(19) United States
(12) Patent Application Publication
(10) Pub. No.: US 2024/0039717 A1
(43) Pub. Date: Feb. 1, 2024

(54) APPRATUS AND METHOD FOR CONTROLLING A CRITICAL SYSTEM

(71) Applicant: HITACHI RAIL STS S.P.A., NAPOLI (IT)

(72) Inventors: Claudio PLESCOVICH, GENOVA (IT); Paolo SANNINO, NAPOLI (IT)

(21) Appl. No.: 18/255,013

(22) PCT Filed: Dec. 1, 2021
(86) PCT No.: PCT/IB2021/061174

§ 371 Date: May 30, 2023

(30) Foreign Application Priority Data
Dec. 2, 2020 (IT) 102020000029450

(51) Int. Cl. H04L 9/08; H04L 9/30

(52) U.S. Cl. CPC H04L 9/088; H04L 9/30

(57) ABSTRACT

The invention relates to an apparatus (1a) and a method for controlling a critical system (S), as well as to a device (3a,3b) and a method for the distribution of messages for controlling said critical system (S), wherein said apparatus (1a) is configured for encrypting a first control message by using the first private key, transmitting said first encrypted message to a second apparatus (1b), receiving a second encrypted message generated by a second apparatus (1b) and encrypted by said second apparatus (1b) by using a second private key, decrypting said second encrypted message by using a public key associated with said second private key, verifying the second decrypted message on the basis of said first message and, if the verification is successful, encrypting at least said second encrypted message with said first private key, thereby generating a third encrypted message, and transmitting said third encrypted message.

The present invention relates to an apparatus and a method for controlling a critical system, as well as to a device and a method for the distribution of messages for controlling said critical system; in particular, for controlling a railway system.

As is known, the development of railway networks that has occurred in the last decades has brought along an increased level of automation, especially as concerns network and traffic control and supervision. However, this increased level of automation ha also caused higher requirements in terms of communication bandwidth necessary for operating the control and supervision apparatuses, and also as concerns the time interval during which such apparatuses must remain available.

As specified by the CENELEC EN 50159 and later standards, such apparatuses must operate with a Safety Integrity Level (SIL) of 4. One way to ensure compliance with such requirements is to use safe processing systems (Safe Calculators) performing the task of collecting, processing and communicating vital information and/or commands (necessary for the safe operation of the controlled railway network) in the form of time-variant communications protected by digital signature. Such apparatuses are very often designed by using redundant architectures (2002), i.e. by using a pair of apparatuses (each one of which is also known as a “replica”), wherein each one of them must process the information and jointly authorize the transmission of a valid vital message. In this context, it is necessary to guarantee the safety of such communications, i.e. to design the system in a manner such that, should the replicas be in disagreement, it will not be possible to send a valid vital message, which may potentially be dangerous. This task is normally entrusted to a third device, i.e. an intrinsic-safety circuitry normally referred to as “Watchdog”, which performs the function of allowing or safely interrupting outbound communications. Therefore, this device permits disabling both apparatuses in the event that any discordance between the replicas is detected; in fact, such discordance is typically a symptom of malfunction. In the railway field, by disabling such apparatuses it is possible to bring the controlled transport systems (e.g. trains, points, signals or the like) back into a safe state, which is typically defined in the design phase, such as, for example, a state in which the signals are either off or red, train traffic is inhibited, and the points are set to avoid a collision between running trains.

The presence of this circuitry often limits the performance of the system and increases the probability that a fault may occur which will stop circulation, since said system is made up of a large number of components that make it rather complex.

This problem is solved by Italian patent application no. 102016000116085 by HITACHI RAIL STS S.p.A., wherein, however, the task of verifying the integrity of the messages is entrusted to their recipients, thus limiting the possibility of using components that are already available on the market (known as “COTS components”—Commercial Off-the-Shelf components) or even already installed along an operational railway network.

German patent application publication no. DE 10 2016 204 630 A1 describes a system capable of allowing the transmission of messages among devices of a railway system without requiring the provision of specific keys for such devices, e.g. in the form of authentication keys.

The present invention aims at solving these and other problems by providing an apparatus and a method for generating messages for controlling a railway network according to the invention.

The present invention aims at solving these and other problems by providing an apparatus and a method for controlling a critical system.

Moreover, the present invention aims at solving these and other problems by providing also a device for the distribution of messages for controlling a critical system.

The basic idea of the present invention is to repeatedly encrypt a control message by using at least two private keys, i.e. configuring each one of at least one pair of apparatuses according to the invention for executing the following steps:
generating a control message, preferably by means of suitable control logics;
receiving an encrypted message from the other apparatus;
decrypting said encrypted message by using a public cryptographic key;
verifying the decrypted message by comparing it with the generated control message and, if the verification is successful, encrypting at least said second encrypted message with a first private cryptographic key, thereby generating a second encrypted message, encrypted with at least two private keys;
transmitting said second encrypted message to a third apparatus, to a message distribution device according to the invention, or to another recipient (e.g. a controller, a signal, or the like).

This ensures safety in terms of protection of things and/or people, in that it is possible to verify that the messages have been validated by at least two control apparatuses and to guarantee that the messages will always travel in encrypted form, thus ensuring redundancy without transmitting any plaintext information.

As aforementioned, a third apparatus may also be included which, as will be further explained hereinafter, participates in the message verification process in series with or parallel to the other two apparatuses, so as to increase the system redundancy level.

It must be pointed out that the number of apparatuses may be increased at will, so as to fulfil most redundancy requirements of critical systems.

Railway control systems can thus be used which are no longer based on dedicated fault-tolerant architectures (such as, for example, 2oo2 or similar architectures envisaging the use of voting systems, watchdogs, etc.), but based on COTS components (e.g. hardware and operating systems based on x86 or x64 architectures), which are well suited to using distributed virtualization technologies (the so-called “cloud”); indeed, the use of such technologies permits implementing railway control systems in such a way as to increase their availability, thus advantageously improving the quality of the control service provided in the railway field and elsewhere as well. As a matter of fact, the use of technologies like virtualization makes it possible to (remotely) control critical systems (e.g. elevators, cableways, subways, tram cars, trolley buses, or the like) without having to install any control systems on site, which, as is known, would take up room and require maintenance. With this invention, it is possible to concentrate critical-system control systems into a single server farm where, due to large hardware availability and virtualization technology, longer availability times can be guaranteed for the control systems, along with a higher level of physical security (e.g. against theft, damage, power failures, or the like) and logical security (e.g. against cyber attacks, deteriorated or faulty mass storage units, or the like).

Further advantageous features of the present invention will be set out in the appended claims.

These features as well as further advantages of the present invention will become more apparent in the light of the following description of a preferred embodiment thereof as shown in the annexed drawings, which are provided merely by way of non-limiting example, wherein:

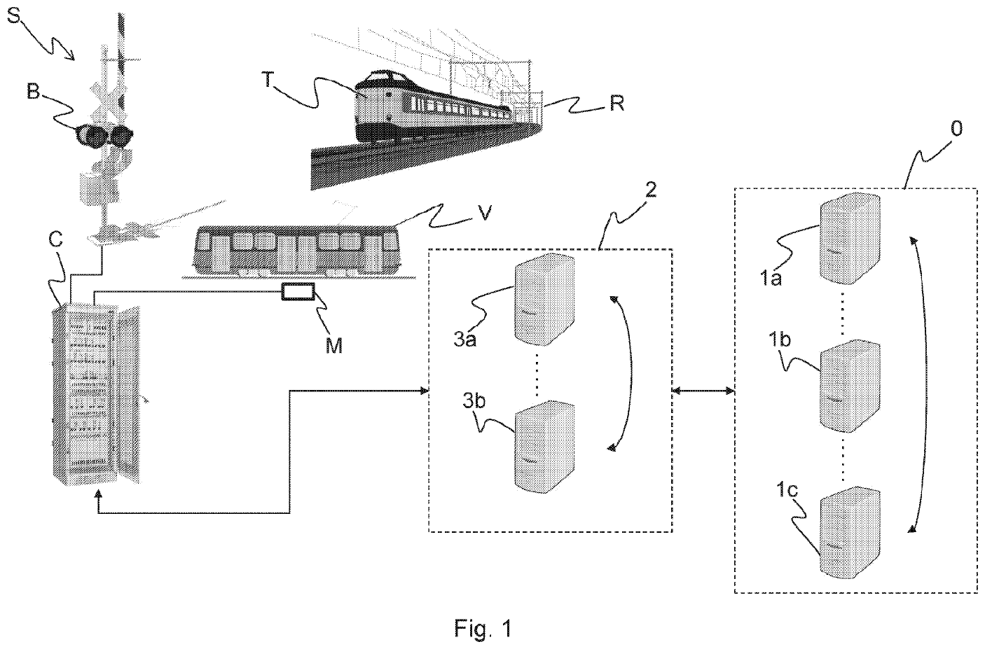

FIG. 1 shows a railway system comprising three apparatuses according to the invention;

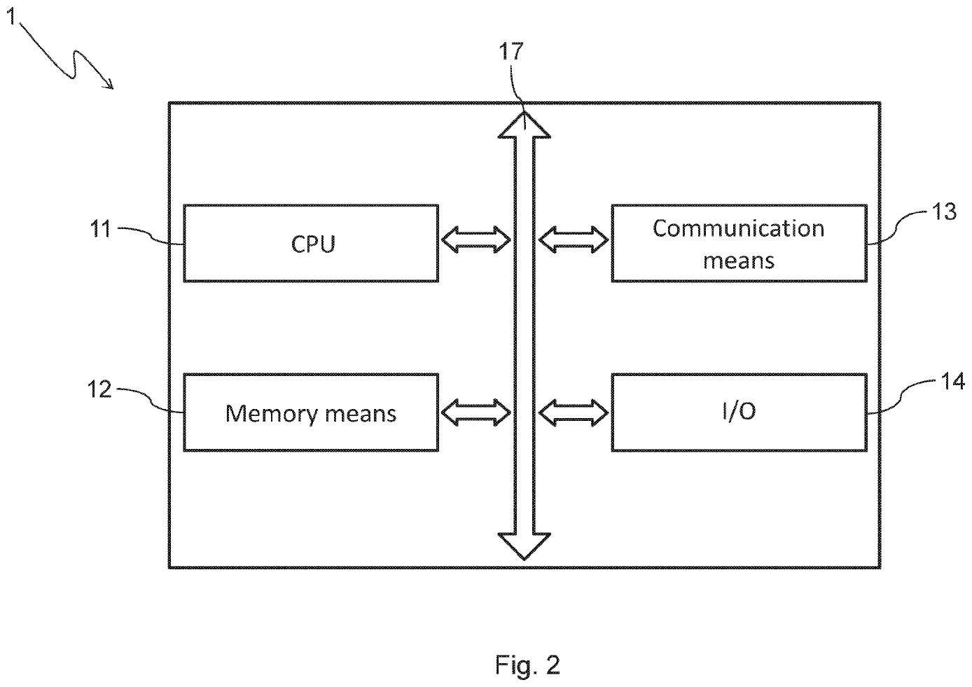

FIG. 2 shows an architecture of each one of the apparatuses of FIG. 1;

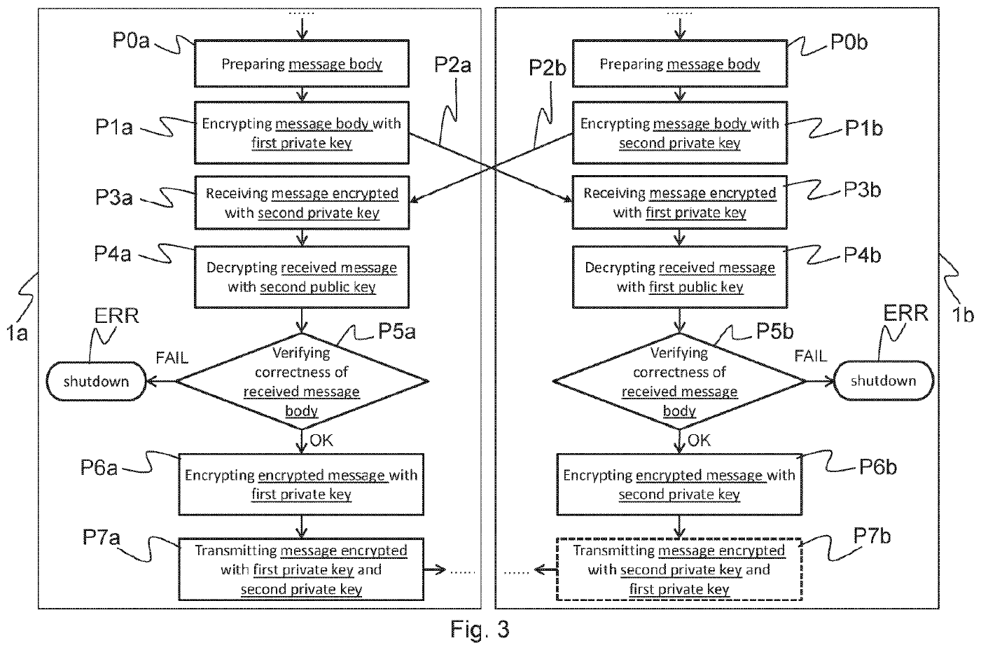

FIG. 3 shows a block diagram that describes the operation of the apparatuses of FIG. 1 when they execute a set of instructions implementing a method according to the invention.

In this description, any reference to “an embodiment” will indicate that a particular configuration, structure or feature is comprised in at least one embodiment of the invention.

Therefore, expressions such as “in an embodiment” and the like, which may be found in different parts of this description, will not necessarily refer to the same embodiment. Moreover, any particular configuration, structure or feature may be combined as deemed appropriate in one or more embodiments. The references below are therefore used only for simplicity's sake, and shall not limit the protection scope or extension of the various embodiments.

With reference to FIG. 1, the following will describe a critical system S, i.e. a railway system; said railway system S preferably comprises the following parts:
a railway line R, along which at least one train T can run;
a level crossing signal B comprising a movable barrier;
a sensor M, e.g. an induction, magnetic, etc. sensor, adapted to detect the presence of another vehicle V (e.g. a tram car) that is engaging the level crossing;
a message distribution system 2, wherein said device is in communication with at least the signal B and the sensor M, preferably in an indirect manner, i.e. via a yard controller C that will be further described below;
a system 0 for the generation of messages for controlling the critical system S, comprising
   a first apparatus 1a according to the invention, preferably in communication with the message distribution system 2;
   a second apparatus 1b according to the invention, preferably in communication with the first apparatus 1a and with the message distribution system 2.

The apparatuses 1a and 1b are configured for mutually communicating over a data communication network, preferably a private local area network. When said apparatuses 1a,1b are installed in distinct locations, the network is preferably a public one, e.g. the Internet or a Multiprotocol Label Switching (MPLS) network.

It must be pointed out that in the following description reference will be made to a level crossing for illustrative purposes only, since the subject of the invention is also applicable to other parts of a railway system that need to generate messages for controlling the railway network (e.g. railway carriages, points, supervision systems, etc.).

It must also be pointed out that the system 0 may additionally comprise one or more further apparatuses that, as aforementioned, contribute to increasing the redundancy level of the system 0. For greater clarity, this description will first illustrate an exemplary embodiment envisaging interaction between the apparatuses 1a and 1b, followed by an example wherein a third apparatus 1c (included in the system 0) interacts with the first two apparatuses 1a,1b.

As will be further described below, the message distribution system 2 comprises at least one first message distribution device 3a according to the invention and optionally one or more second message distribution devices 3b according to the invention, wherein said devices 3a and 3b are configured for communicating with each other over a second data communication network, preferably a private local area network. When said devices 3a,3b are installed in distinct locations, the network is preferably a public one, e.g. the Internet or a Multiprotocol Label Switching (MPLS) network.

Also with reference to FIG. 2, the following will describe the apparatus 1 (designated in FIG. 1 by the symbols 1a and 1b); said apparatus 1 comprises the following components:
control and/or processing means 11 (also referred to as CPU for brevity), e.g. one or more CPUs and/or a microcontroller and/or an FPGA and/or a CPLD and/or the like, adapted to allow the generation of messages for controlling the railway network, preferably in a programmable manner, via the execution of appropriate instructions;
memory means 12, e.g. a random access memory (RAM) and/or a Flash memory and/or another type of memory, in signal communication with the control and/or processing means 11, wherein said volatile memory means 12 preferably store at least the instructions that implement the method according to the invention, which can be read by the control and/or processing means 11 when the apparatus 1 is in an operating condition; also, said memory means 12 preferably contain cryptographic keys (which will be further described hereinafter) and may also contain a set of instructions implementing the control logics that will allow said apparatus 1 to control a portion of the railway network;
communication means 13, preferably an interface operating in accordance with one of the communication standards allowed by the ERTMS/ETCS system or one of the standards belonging to the IEEE 802.3 (also known as Ethernet), IEEE 802.11 (also known as WiFi) or 802.16 (also known as WiMax) families, or an interface to a GSM-R or GSM/GPRS/UMTS/LTE or TETRA data network, which allow the apparatus 1 to communicate with the other apparatus 1b and/or with other elements, such as the message distribution system 2 or other apparatuses included in the railway system S;
input/output means (I/O) 14, which may be used, for example, for connecting said apparatus 1 to a programming terminal configured for writing instructions (which the CPU 11 will then have to execute) into the memory means 12 and/or allowing the diagnosis of any failures suffered by said apparatus 1; such input/output means 14 may comprise, for example, a USB, Firewire, RS232, IEEE 1284, Ethernet, WiFi or Bluetooth adapter, or the like;
a communication bus 17 allowing information to be exchanged among the control and/or processing means 11, the memory means 12, the communication means 13 and the input/output means 14.

As an alternative to the communication bus 17, the control and/or processing means 11, the memory means 12, the communication means 13 and the input/output means 14 may be connected by means of a star architecture.

Each one of the devices 3a,3b has an internal architecture that is similar to that of the apparatuses 1a,1b. More in detail, said device 3a,3b comprises control and/or processing means (e.g. a CPU) and communication means (e.g. an Ethernet card or another type of card) in communication with the signal B and the sensor M (the so-called yard equipment), preferably via the controller C, which controls their operation; for this purpose, said controller C comprises input/output means (I/O) that may comprise, for example, a board including one or more relays capable of controlling the movement of the barrier of the signal B according to a value contained in a control message received from one or more of said devices 3a,3b.

The devices 3a,3b may be configured to be mutually redundant, or each one of them may be connected to a distinct controller that controls a distinct set of yard devices. Moreover, as will be further described below, the devices 3a,3b may be configured for decrypting the messages much like the apparatuses 1,1a,1b, so as to ensure the presence and proper operation of a given number (e.g. two or more) of said devices 3a,3b.

Also with reference to FIG. 3, the following will describe a method for the generation of messages for controlling a railway network according to the invention, wherein said method is implemented by a set of instructions that can be executed by each one of the apparatuses 1a and 1b.

When each apparatus 1a and 1b is in an operating condition, the control and/or processing means 11 execute a set of instructions implementing a message preparation phase P0a,P0b, during which the CPU 11 generates a first message, which is preferably determined on the basis of the control logics stored in the memory means 12 and of the state of the railway system S, which may comprise, for example, a datum representative of a sensor signal generated by the sensor M and/or by the signal B and received via the communication means 13, or the like.

Furthermore, the set of instructions executed by the control and/or processing means 11 (stored in the memory means 12) also implements the control method according to the invention; said method comprises at least the following phases:
a. a first encryption phase P1a,P1b, wherein said first message is encrypted, by control and/or processing means 11, by using a first private cryptographic key, thereby generating a first encrypted message;
b. a first transmission phase P2a,P2b, wherein said first encrypted message is transmitted, via communication means 13, to a second apparatus 1,1a,1b;
c. a first reception phase P3a,P3b, wherein a second encrypted message, generated by the second apparatus 1,1a,1b and encrypted by said second apparatus 1,1a,1b by using a second private cryptographic key, is received via the communication means 13;
d. a first decryption phase P4a,P4b, wherein said second encrypted message is decrypted, by the control and/or processing means 11, by using a public cryptographic key associated with said second private cryptographic key, thereby generating a second decrypted message;
e. a first verification phase P5a,P5b, wherein said second decrypted message is verified, by the control and/or processing means 11, on the basis of said first message (e.g. by making a bitwise comparison between the two messages or at least a portion thereof, so as to verify their equality), and wherein, if the verification fails, the control and/or processing means will preferably go into an error state ERR, in which the apparatus 1a,1b will preferably try to synchronize (again) with the other apparatus 1a,1b;
f. a second encryption phase P6a,P6b, wherein, if the verification phase is successful, said second encrypted message is encrypted, by the control and/or processing means 11, with said first private cryptographic key, thereby generating a third encrypted message;
g. a second transmission phase P7a,P7b, wherein said third encrypted message is transmitted, via the communication means 13, to a recipient, e.g. the message distribution system 2 or a third apparatus 1c (similar or equal to the apparatuses 1a,1b, the operation of which will be further described below).

It must be pointed out that the apparatus 1 may be configured for executing these phases not in strict succession, i.e. the phases c. and d. may begin when the phases a. e b. have not yet been completed.

When the device 3a,3b is in an operating condition, the control and/or processing means of said device 2 execute a set of instructions stored in the memory means of said device 2 that implements a method for the distribution of messages for controlling a critical system according to the invention, wherein said method comprises the following phases:
a. a terminal reception phase, wherein an encrypted message is received, via the communication means, from at least one apparatus 1,1a,1b, wherein said message has been encrypted by using at least the first private cryptographic key and the second private cryptographic key;
b. a terminal decryption phase, wherein said encrypted message is decrypted, by the control and/or processing means, by using at least one public cryptographic key associated with said first private cryptographic key and/or with said second private cryptographic key, thereby generating a first decrypted message (as will be further explained below);
c. a terminal transmission phase, wherein said decrypted message is transmitted, via the communication means, to at least one device comprised in said critical system, e.g. the level crossing signal B and/or the sensor M, or the like, preferably through the controller C that controls the operation thereof.

It must be pointed out that, if either one of the apparatuses 1a,1b has not executed the second encryption phase P6a,P6b (e.g. because of a failed first verification phase P5a,P5b), should the message signed by only one of the apparatuses 1a,1b reach the device 3a,3b, the terminal decryption phase would fail or would anyway produce an invalid plaintext message, thus ensuring the safety of the critical system S.

This ensures safety in terms of protection of things and/or people, in that it is possible to verify that the messages have been validated by at least two control apparatuses and to guarantee that the messages will always travel in encrypted form, thus ensuring redundancy without transmitting any plaintext information. It is thus possible to use control systems based on COTS components, which are well suited to the use of distributed virtualization technologies.

The public and private cryptographic keys used by the apparatuses 1,1a,1b can be generated in pairs by using well-known encryption algorithms, such as RSA (Rivest-Shamir-Adleman), DSA (Digital Signature Algorithm), ECC (Elliptic Curve Cryptography), or other algorithms as well. As an alternative to these algorithms for the generation of pairs of public and private keys, the following relation may be used:

PRᵢ[x]+PUᵢ[x]=LOOP (1)

where PRᵢ[x] indicates the x-th integer (preferably a 16-bit integer) forming the i-th private cryptographic key, while PUᵢ[x] indicates the x-th integer (preferably a 16-bit integer) forming the i-the public cryptographic key associated with said i-th private cryptographic key. As can be seen, the sum of the x-th integers (preferably a 16-bit integer) that constitute the i-th pair of keys has a value equal to the LOOP constant.

It must be highlighted that the keys PUᵢ and PRᵢ preferably have the same length, which equals the length of the message M.

Should the message be longer than the key, the bits composing the key may be cyclically reused, so as to obtain a (pseudo) key which is as long as said message M.

During the encryption phases P1a,P1b, the encryption operations (using an i-th private cryptographic key PRᵢ) are preferably carried out by executing, via the control and/or processing means 11, a set of instructions implementing the following relation:

E(M,PRᵢ)=∀x|x∈(1,len(M)),{(M[x]+PRᵢ[x])mod LOOP} (2)

where len(M) is the length of the message M (i.e. the number of integers, preferably 8-bit ones, that make up the message M), M[x] is the x-th integer of the message M, and wherein the x-th integer of the encrypted message E(M,PRᵢ)[x] is the remainder of the division by LOOP of the sum of the x-th integer of the message M (M[x]) and the x-th integer of the i-th private cryptographic key (PRᵢ[x]).

During the first decryption phase P4a,P4b, the operations of decrypting (with an i-th public cryptographic key PUᵢ) the encrypted message (MC) received during the first reception phase P3a,P3b are preferably carried out by executing, via the control and/or processing means 11, a set of instructions implementing the following relation:

D(MC,PUᵢ)=∀x|x∈(1,len(MC)),{(MC[x]+PUᵢ[x])mod LOOP} (3)

During the encryption phase P6a,P6b (which is only executed when the first verification phase P5a,P5b has been completed successfully), the encryption operations (using a j-th private cryptographic key PRⱼ) are preferably carried out by executing, via the control and/or processing means 11, a set of instructions implementing the following relation:

$$E ( MC , E ( M , {PR}_{j} ) ) = E ( E ( M , {PR}_{i} ) , E ( M , {PR}_{j} ) ) = ∀ x \vert x ∈ ( 1 , len ( M ) ) , \{ ( E ( M , {PR}_{i} ) [ x ] + E ( M , {PR}_{j} ) [ x ] ) mod LOOP \} \qquad ( 4 )$$

where the message received during the first reception phase P3a, P3b (E(M,PRᵢ)) is combined with the result of the operation of encrypting the (verified) message M executed by using the j-th private cryptographic key. This (as will be described below) makes it possible to speed up the decryption operations to be carried out by the device 3a,3b; moreover, the sum operations described in the above relation 4 can be executed in succession, so as to advantageously permit the execution of the encryption phase P6a,P6b as soon as the decryption phases P4a,P4b and the verification phases P5a,P5b have produced their partial results, thus speeding up the exchanges among the different apparatuses 1,1a,1b and, therefore, reducing the time necessary for completing the entire method for controlling the critical system S according to the invention.

During the terminal decryption phase executed by the device 3a,3b, the operations of decrypting a message encrypted with at least two private keys (PRᵢ,PRⱼ) are preferably carried out by executing, via the control and/or processing means 11, a set of instructions implementing the following relation (which, as will be further described below, is similar to the above relation 3):

$$D ( MCC , {PU}_{ij} , n ) = ∀ x \vert x ∈ ( 1 , len ( MCC ) ) , \{ \frac{( MCC [ x ] + {PU}_{ij} [ x ] ) mod LOOP}{n} \} \qquad ( 5 )$$

where MCC is the message encrypted by executing the set of instructions described by relation 4, where n is the redundancy level (i.e. the number of apparatuses 1 that encrypted the message MCC, which in the example shown in FIG. 3 is two), and where the public cryptographic key PUᵢⱼ is obtained (preferably asynchronously (offline) with respect to the execution of the message distribution method according to the invention) by executing a set of instructions implementing the following relation:

PUᵢⱼ=∀x|x∈(1,len(PUᵢ)),{(PUᵢ[x]+PUⱼ[x])mod LOOP} (6)

As aforementioned, relation 5 is similar (except for the division by n) to relation 4; in fact, by combining together (by means of relation 6) the two public keys associated with the two private keys used for encrypting the message M, it is advantageously possible to decrypt the message MCC with a single decryption operation. In other words, during the terminal decryption phase the public cryptographic key employed is the result of an (arithmetical) combination between at least the first private cryptographic key and the second private cryptographic key respectively used by the apparatuses 1a,1b.

This approach reduces the complexity of the decryption operation, advantageously also decreasing—in addition to computational complexity—the number of failure modes that may occur during the execution of the message distribution method according to the invention, resulting in improved safety in terms of protection of things and/or people, since it is possible to verify that the messages have been validated by at least two control apparatuses and to ensure that the messages will always travel in encrypted form, thus ensuring redundancy without transmitting any plaintext information. As a result, it becomes possible to use control systems based on COTS components, which are well suited to the use of distributed virtualization technologies.

Due to the very advantages described above, it is also advantageously possible to configure the apparatus 1,1a,b for using (during the second decryption phase of the control method according to the invention) a public cryptographic key associated with said second private cryptographic key and said third private cryptographic key, wherein said public cryptographic key is the result of a combination between at least said second public cryptographic key and said third public cryptographic key.

In addition to the above, the first apparatus 1a and/or the second apparatus 1b may be configured for transmitting (during the second transmission phase P7a,P7b) the second encrypted message to the third apparatus 1. This makes it possible to obtain a further validation of the control message by another control apparatus, thereby increasing the redundancy level of the whole system S. To this end, the control method according to the invention (which is executed by all three apparatuses 1,1a,1b) preferably comprises also the following steps:
h. a second reception phase, wherein a fourth encrypted message is received, via the communication means 13, which was generated by the third apparatus 1c with a third private cryptographic key starting from a message (already) encrypted (by at least the second apparatus 1b) with at least the second private cryptographic key;
i. a second decryption phase, wherein said fourth encrypted message is decrypted, by the control and/or processing means 11, by using at least one public cryptographic key associated with said second private cryptographic key and/or with said third private cryptographic key, thereby generating a fourth decrypted message (e.g. by executing a set of instructions implementing relation 5, where D(MCC,PUᵢⱼ,n) with n=2);
j. a second verification phase, wherein said fourth decrypted message is verified, by the control and/or processing means 11, on the basis of said first message (e.g. by making a bitwise comparison between the two messages or at least a portion thereof, so as to verify their equality);
k. a third encryption phase, wherein, if the verification phase was successful, said fourth encrypted message is encrypted, by the control and/or processing means 11, with the first private cryptographic key, thereby generating a fifth encrypted message (e.g. by executing a set of instructions implementing relation 4, where E(E(M,PRᵢ),MCC));
l. a third transmission phase, wherein said fifth encrypted message is transmitted, via the communication means 13, to a recipient, e.g. the device 3a,3b (if the verification process has ended) or a fourth apparatus 1 (if an additional level of redundancy is required).

During the terminal decryption phase, the public cryptographic key used by the device 3a,3b is obtained by (arithmetically) combining the first public cryptographic key, the second public cryptographic key and the third public cryptographic key, e.g. by executing a set of instructions (preferably asynchronously (offline) with respect to the execution of the message distribution method according to the invention) implementing the following relation:

PUᵢⱼₖ=∀x|x∈(1,len(PUᵢⱼ)),{(PUᵢⱼ[x]+PUₖ[x])mod LOOP} (7)

where PUᵢⱼₖ is the public cryptographic key that, by executing the instructions that implement relation 5 (D(MCCC,PUᵢⱼₖ,n) with n=3), permits decrypting a message encrypted with each one of the three private keys stored in the respective apparatuses 1,1a,1b.

As in the second encryption phase P6a,P6b, it must be highlighted that, if either one of the apparatuses 1,1a,1b has not executed the third encryption phase (e.g. due to a failed second verification phase), should the message signed by only one or two of the apparatuses 1a,1b reach the device 3a,3b, the terminal decryption phase would fail or anyway would produce an invalid plaintext message, thus ensuring the safety of the critical system S.

By observing relations 6 and 7 one can understand that this approach can be extended to an arbitrary number of keys, so as to increase to redundancy level without, advantageously, increasing the computational load on the device 3a,3b.

It must be pointed out, in fact, that the redundancy level can be increased at will (in order to fulfil the requirements of a specific application context) by transmitting the message to one or more additional apparatuses 1, depending on the specific application context in which the invention is to be used.

This advantageously increases the redundancy level, making it possible to improve safety in terms of protection of things and/or people, in that it is possible to verify that the messages have been validated by at least three control apparatuses and to guarantee that the messages will always travel in encrypted form, thus ensuring redundancy without transmitting any plaintext information. It is thus possible to use control systems based on COTS components, which are well suited to the use of distributed virtualization technologies.

When two or more devices 3a,3b are used, it is possible to ensure that a given number of said devices 3a,3b are properly operational by configuring each device 3a,3b for executing, during the terminal decryption phase, the following sub-phases:
decrypting said encrypted message by using at least the first public cryptographic key associated with at least said first private cryptographic key, thereby generating a first semi-decrypted, i.e. partially decrypted and still ciphertext, message;
transmitting, via the communication means of said device, said first semi-decrypted message, preferably to the other (second) device 3a,3b;
receiving, via the communication means of said device 3a,3b, a second semi-decrypted (i.e. partially decrypted) message, wherein said second decrypted message has been decrypted by using at least one fourth public cryptographic key associated with at least said second private cryptographic key;
decrypting, by the control and/or processing means, said second semi-decrypted message by using the first public cryptographic key associated with at least said first private cryptographic key, thereby generating the plaintext message, e.g. by executing a set of instructions implementing relation 3.

This makes it advantageously possible to prevent the encrypted message from being decrypted in the event that at least two (or more) of said devices 3a,3b are not operational.

Indeed, by generating public keys in such a way that each one of them is only associated to a part of the private keys used for encrypting the message, it is possible to prevent message decryption. For example, if a message has been encrypted by using four private keys (i.e. has been generated by using four apparatuses 1,1a,1b,1c), the first public key can be generated on the basis of the public keys associated with the first private key and the third private key, and the fourth public key on the basis of the public keys associated with the second private key and the third private key, preferably by executing the instructions implementing the above relation 7.

It is thus possible to increase the number of failure modes of the critical system S that can advantageously be excluded, thereby increasing safety in terms of protection of things and/or people and ensuring redundancy without transmitting any plaintext information.

Of course, the example described so far may be subject to many variations.

In a first variant, when the apparatuses according to the invention are at least three, said apparatuses do not execute a first verification phase P5a,P5b and a second verification phase, but just a single verification phase, in which all verification operations are concentrated.

More in detail, the control and/or processing means 11 are configured for executing the phases of the method according to the invention as follows:
during the transmission phase, said first encrypted message is transmitted (via the communication means 13) to the second apparatus and also to a third apparatus;
during the first reception phase, at least one fourth encrypted message, generated by the third apparatus and encrypted by said third apparatus by using a third private cryptographic key, is also received (via the communication means 13);
during the decryption phase, also said fourth encrypted message is decrypted by using a public cryptographic key associated with said third private cryptographic key, thereby generating a third decrypted message;
during the first verification phase, also at least said third decrypted message is verified on the basis of the (first) message generated by said control and/or processing means 11 as described with reference to the main embodiment;
during the second encryption phase, if the first verification phase was successful, at least said second encrypted message and said fourth encrypted message are encrypted with said first private cryptographic key, thereby generating the third encrypted message, which will then be transmitted as described with reference to the main embodiment.

It must be pointed out that, during the second encryption phase, the second encrypted message and the third encrypted message are combined together (e.g. combined according to the above relation 4), so that with a single encryption operation it is possible to confirm the successful verification of all the messages produced by the other apparatuses. This makes it possible to advantageously increase the number of said apparatuses without significantly increasing the length of the operations necessary for verifying the message.

It is thus possible to verify that the messages have been validated by at least three control apparatuses and to ensure that the messages will always travel in encrypted form, thereby increasing safety in terms of protection of things and/or people and ensuring redundancy without transmitting any plaintext information.

In a further variant, the messages prepared and sent by the apparatuses according to the invention (i.e. by the message generation system 0, see FIG. 1) are not sent to the message distribution system 2, but directly to the controller C or the signal S, wherein said controller C or said signal S are configured for executing the phases of the method for the distribution of messages according to the invention.

This makes it possible to manage a situation in which the message distribution system 2 is faulty or absent, so as to increase the redundancy level and hence the safety level in terms of protection of things and/or people without transmitting any plaintext information.

Some of the possible variants of the invention have been described above, but it will be clear to those skilled in the art that other embodiments may also be implemented in practice, wherein several elements may be replaced with other technically equivalent elements. The present invention is not, therefore, limited to the above-described illustrative examples, but may be subject to various modifications, improvements, replacements of equivalent parts and elements without however departing from the basic inventive idea, as specified in the following claims.

1-19. (canceled)

20. An apparatus for controlling a critical system, comprising:
memory means containing at least one first private cryptographic key,
communication means adapted to communicate with a second apparatus,
control and/or processing means in communication with said memory means and said communication means, wherein said control and/or processing means are configured for generating a first message comprising information that can change a state of said critical system,
wherein said control and/or processing means are also configured for:
encrypting said first message by using the first private cryptographic key, thereby generating a first encrypted message,
transmitting, via the communication means, said first encrypted message to at least the second apparatus,
receiving, via the communication means, at least one second encrypted message generated by the second apparatus and encrypted by said second apparatus by using a second private cryptographic key,
decrypting said second encrypted message by using a public cryptographic key associated with said second private cryptographic key, thereby generating a second decrypted message,
verifying at least said second decrypted message on the basis of said first message and, if the verification is successful, encrypting at least said second encrypted message with said first private cryptographic key, thereby generating a third encrypted message,
transmitting, via the communication means, said third encrypted message to a recipient.

21. The apparatus according to claim 20, wherein the control and/or processing means are also configured for
receiving, via the communication means, a fourth encrypted message generated by a third apparatus with a third private cryptographic key starting from a message encrypted with at least the second private cryptographic key,
decrypting said fourth encrypted message by using at least a second public cryptographic key associated with said second private cryptographic key and/or with said third private cryptographic key, thereby generating a fourth decrypted message,
verifying said fourth decrypted message on the basis of the first message and, if the verification is successful, encrypting said fourth encrypted message with the first private cryptographic key, thereby generating a fifth encrypted message,
transmitting, via the communication means, said fifth encrypted message.

22. The apparatus according to part of claim 21, wherein the second public cryptographic key associated with said second private cryptographic key and with said third private cryptographic key is the result of a combination between at least
a fourth public cryptographic key associated with said second private cryptographic key, and
a third public cryptographic key associated with said third private cryptographic key.

23. The apparatus according to claim 20, wherein the control and/or processing means are also configured for
transmitting, via the communication means, said first encrypted message also to a third apparatus,
receiving, via the communication means, also at least one fourth encrypted message generated by the third apparatus and encrypted by said third apparatus by using a third private cryptographic key,
decrypting also said fourth encrypted message by using a fifth public cryptographic key associated with said third private cryptographic key, thereby generating a third decrypted message,
verifying also at least said third decrypted message on the basis of said first message and, if the verification is successful, encrypting at least said second encrypted message and said fourth encrypted message with said first private cryptographic key, thereby generating said third encrypted message.

24. A system for the generation of messages for controlling the critical system, comprising:
a first apparatus and a second apparatus according to claim 20,
wherein said first apparatus and said second apparatus are configured for communicating with each other over a data communication network.

25. A method for controlling a critical system through at least one first message comprising information that can change a state of said critical system, comprising:
a first encryption phase, wherein said first message is encrypted, by control and/or processing means, by using a first private cryptographic key, thereby generating a first encrypted message,
a first transmission phase, wherein said first encrypted message is transmitted, via communication means, to at least one second apparatus,
a first reception phase, wherein at least one second encrypted message, generated by the second apparatus and encrypted by said second apparatus by using a second private cryptographic key, is received via the communication means,
a first decryption phase, wherein said second encrypted message is decrypted, by the control and/or processing means, by using a public cryptographic key associated with said second private cryptographic key, thereby generating a second decrypted message,
a first verification phase, wherein at least said second decrypted message is verified, by the control and/or processing means, on the basis of said first message,
a second encryption phase, wherein, if the first verification phase was successful, at least said second encrypted message is encrypted, by the control and/or processing means, with said first private cryptographic key, thereby generating a third encrypted message,
a second transmission phase, wherein said third encrypted message is transmitted, via the communication means, to a recipient.

26. The method according to claim 25, further comprising:
a second reception phase, wherein a fourth encrypted message, generated by a third apparatus with a third private cryptographic key starting from a message encrypted with at least the second private cryptographic key, is received via the communication means,
a second decryption phase, wherein said fourth encrypted message is decrypted, by the control and/or processing means, by using at least one second public cryptographic key associated with said second private cryptographic key and/or with said third private cryptographic key, thereby generating a fourth decrypted message,
a second verification phase, wherein said fourth decrypted message is verified, by the control and/or processing means, on the basis of the first message,
a third encryption phase, wherein, if the verification phase was successful, said fourth encrypted message is encrypted, by the control and/or processing means, with the first private cryptographic key, thereby generating a fifth encrypted message,
a third transmission phase, wherein said fifth encrypted message is transmitted via the communication means.

27. The method according to part of claim 26, wherein, during the second decryption phase, the second public cryptographic key associated with said second private cryptographic key and with said third private cryptographic key is the result of a combination between at least
a fourth public cryptographic key associated with said second private cryptographic key, and
a third public cryptographic key associated with said third private cryptographic key.

28. The method according to claim 25, wherein,
during the transmission phase, said first encrypted message is transmitted also to a third apparatus,
during the first reception phase, at least one fourth encrypted message, generated by the third apparatus and encrypted by said third apparatus by using a third private cryptographic key, is also received,
during the decryption phase, also said fourth encrypted message is decrypted by using a fifth public cryptographic key associated with said third private cryptographic key, thereby generating a third decrypted message,
during the first verification phase, also at least said third decrypted message is verified on the basis of said first message,
during the second encryption phase, if the first verification phase was successful, at least said second encrypted message and said fourth encrypted message are encrypted with said first private cryptographic key, thereby generating the third encrypted message.

29. A device for the distribution of messages for controlling a critical system, comprising:
memory means containing at least one first public cryptographic key,
communication means adapted to communicate with at least one apparatus in accordance with claim 20,
control and/or processing means in communication with said memory means and said communication means,
wherein said control and/or processing means are configured for:
receiving, via the communication means, an encrypted message from said at least one apparatus, wherein said message has been encrypted by using at least a first private cryptographic key and a second private cryptographic key,
decrypting said encrypted message by using at least the first public cryptographic key associated with at least said first private cryptographic key and/or said second private cryptographic key, thereby generating a plaintext message,
transmitting, via the communication means, said plaintext message to at least one apparatus comprised in said critical system.

30. The device according to claim 29, wherein the encrypted message received has been encrypted by using also a third private cryptographic key.

31. The device according to claim 29, wherein the first public cryptographic key is the result of a combination between at least
a second public cryptographic key associated with at least said first private cryptographic key, and
a third public cryptographic key associated with at least said second private cryptographic key.

32. The device according to claim 29, wherein the control and/or processing means are configured for decrypting said encrypted message by executing the steps of decrypting said encrypted message by using at least the first public cryptographic key associated with at least said first private cryptographic key, thereby generating a first semi-decrypted message,
transmitting, via the communication means, said first semi-decrypted message,
receiving, via said communication means, a second semi-decrypted message, wherein said second decrypted message has been decrypted by using at least one fourth public cryptographic key associated with at least said second private cryptographic key,
decrypting, by the control and/or processing means, said second semi-decrypted message by using the first public cryptographic key associated with at least said first private cryptographic key, thereby generating the plaintext message.

33. A message distribution system for controlling the critical system, comprising:
a first device according and a second device according to claim 29,
wherein said first device and said second device are configured for communicating with each other over a data communication network.

34. A method for the distribution of messages for controlling a critical system,
comprising: a terminal reception phase, wherein an encrypted message is received, via communication means, from at least one apparatus, wherein said message has been encrypted by using at least a first private cryptographic key and a second private cryptographic key;
a terminal decryption phase, wherein said encrypted message is decrypted, by control and/or processing means, by using at least one first public cryptographic key associated with said first private cryptographic key and/or with said second private cryptographic key, thereby generating a plaintext message;
a terminal transmission phase, wherein said plaintext message is transmitted, via said communication means, to at least one apparatus comprised in said critical system.

35. The method according to claim 34, wherein the message received during the terminal reception phase has been encrypted by using also a third private cryptographic key.

36. The method according to claim 34, wherein, during the first terminal decryption phase, the first public cryptographic key is the result of a combination between at least
a second public cryptographic key associated with at least said first private cryptographic key, and
a third public cryptographic key associated with at least said second private cryptographic key.

37. The method according to claim 34, wherein the following sub-steps are executed during the terminal decryption phase:
decrypting, by the control and/or processing means, said encrypted message by using at least the first public cryptographic key associated with at least said first private cryptographic key, thereby generating a first semi-decrypted message,
transmitting, via the communication means, said first semi-decrypted message,
receiving, via said communication means, a second semi-decrypted message, wherein said second decrypted message has been decrypted by using at least one fourth public cryptographic key associated with at least said second private cryptographic key,
decrypting, by the control and/or processing means, said second semi-decrypted message by using the first public cryptographic key associated with at least said first private cryptographic key, thereby generating the plaintext message.

38. A computer program product which can be loaded into the memory of an electronic computer, and which comprises a portion of software code for executing the phases of a method according to claim 25.

39. A computer program product which can be loaded into the memory of an electronic computer, and which comprises a portion of software code for executing the phases of a method according to claim 34.
